(19) United States
(12) Patent Application Publication
(10) Pub. No.: US 2013/0226602 A1
(43) Pub. Date: Aug. 29, 2013

(54) ELECTRONIC PHYSICIAN ORDER SHEET

(71) Applicant: Nathan Goldfein, Tijeras, NM (US)

(72) Inventor: Nathan Goldfein, Tijeras, NM (US)

(73) Assignee: Emergency Medical Services Corporation, Greenwood Village, CO (US)

(21) Appl. No.: 13/598,558

(22) Filed: Aug. 29, 2012

Related U.S. Application Data
(63) Continuation of application No. 12/840,078, filed on Jul. 20, 2010.
(60) Provisional application No. 61/226,986, filed on Jul. 20, 2009.

(51) Int. Cl. G06F 19/00

(52) U.S. Cl. CPC G06F 19/345
USPC 705/2

(57) ABSTRACT

An electronic physician's order sheet (EPOS) provides means for a physician to select or enter diagnoses and to automatically receive suggestions for medications and treatments. The physician can select from amongst the suggestions, select alternate medications and treatments, or input and select different medications or treatments. The EPOS can alert the physician to possible drug interactions, allergic reactions, or other alarming situations. The physician can then sign the EPOS to formally issue orders for treatment and medications. The EPOS can be integrated with billing systems, pharmacy systems, and other systems to help automate the processes of drug delivery, invoicing, and patient care.

### CROSS REFERENCE TO RELATED APPLICATIONS

This patent application is a continuation of, and claims priority to, U.S. non-provisional patent application Ser. No. 12/840,078, filed on Jul. 20, 2010, having the same title, inventor, and assignee, which claims priority to and the benefit of U.S. provisional patent application 61/226,986 filed on Jul. 20, 2009, also having the same title and inventor. The contents of both of these priority patent applications are incorporated herein by reference.

### TECHNICAL FIELD

Embodiments are related to medical diagnosis, medical treatment, medication prescriptions, billing and invoicing. Embodiments are also related to networked computers, electronic forms, and electronic communication.

### BACKGROUND

Physicians typically examine a patient to form a diagnosis, and then order treatment and medication based on the diagnosis. As such, physician's efforts have often centered on writing down the orders for treatment and medication. This can lead to a variety of problems wherein a time constrained physician unintentionally omits things, writes illegibly, or writes the wrong things. Another problem that arises is that the physician's focus is shifted away from diagnosing health issues. This can result in only one primary issue being diagnosed and other issues being missed or ignored. Systems and methods for streamlining the process of providing proper care are needed. Ideally, the systems and processes will encourage physicians to focus on diagnosis and patient care. Furthermore, the systems and methods can detect treatment and medication scenarios that may be harmful to the patient.

### BRIEF SUMMARY

Aspects of the embodiments address limitations and flaws in the prior art by providing an electronic physician order sheet coupled with algorithmic means for suggesting treatments and medications. Furthermore, the algorithmic means can alert physicians and care givers to scenarios that may result in patient harm.

It is therefore an aspect of the embodiments that a presentation device presents a physician with input/output fields for diagnosis, treatment, and medication. The diagnosis field can include a number of suggested diagnoses. Suggested diagnoses are typically those diagnoses that are commonly encountered or for which the treatments and medications are well understood. The physician can make a diagnosis by selecting one or more of the suggested diagnoses.

It is a further aspect of the embodiments that a logic module receives the diagnosis and suggests a medication and an order for treatment. The order and medication suggestions are passed back to the presentation device such that the physician can select any of the suggested orders and medications.

It is another aspect of the embodiments to provide a selection means, such as a touch sensitive display, a touch/signature pad, a mouse, a biometric reader, or another device that the physician can use to select any of the suggested medications and orders. The physician can also use the selection means or a different device to sign or otherwise authenticate the medications and treatments orders that are selected. The signing or authorization step is necessary because it transforms the selected medications and selected orders into the ordered medications and the physician's orders that are actually obeyed to thereby treat a patient.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a system for entering or selecting diagnoses, entering or selecting treatments, entering or selecting medications, and authorizing selections, in accordance with aspects of the embodiments;

FIG. 2 illustrates a provider offering electronic physician's order sheets as a service in accordance with aspects of some embodiments;

FIG. 3 illustrates an alarm module that detects scenarios that can result in patient harm, in accordance with aspects of some embodiments; and

FIG. 4 illustrates a high level flow diagram of a physician using an electronic physicians order sheet in accordance with aspects of the embodiments.

### DETAILED DESCRIPTION OF THE INVENTION

The particular values and configurations discussed in these non-limiting examples can be varied and are cited merely to illustrate embodiments and are not intended to limit the scope of the invention.

An electronic physician's order sheet (EPOS) provides means for a physician to select or enter diagnoses and to automatically receive suggestions for medications and treatments. The physician can select from amongst the suggestions, select alternate medications and treatments, or input and select different medications or treatments. The EPOS can alert the physician to possible drug interactions, allergic reactions, or other alarming situations. The physician can then sign the EPOS to formally issue orders for treatment and medications. The EPOS can be integrated with billing systems, pharmacy systems, and other systems to help automate the processes of drug delivery, invoicing, and patient care.

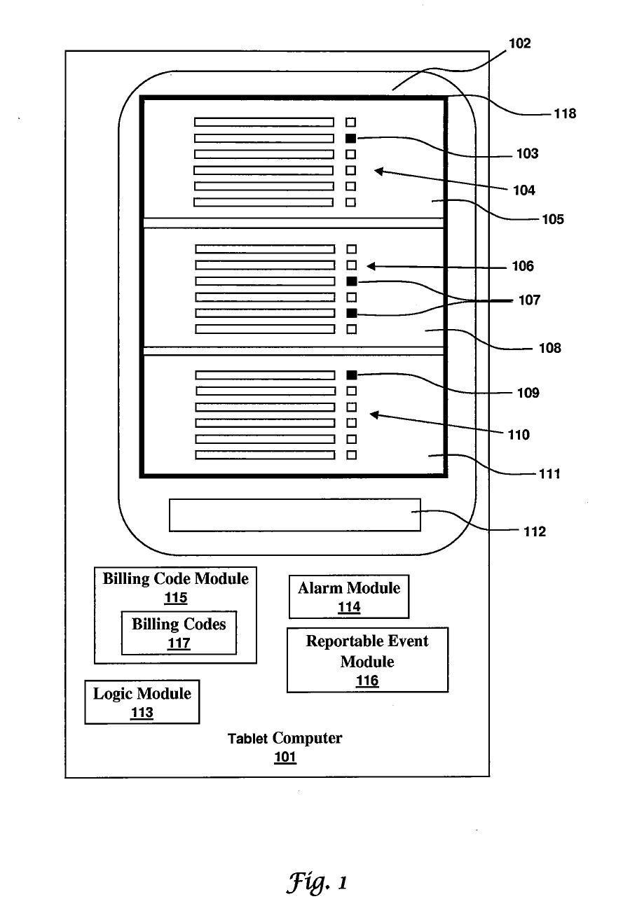

FIG. 1 illustrates a system for entering or selecting diagnoses, entering or selecting treatments, entering or selecting medications, and authorizing selections, in accordance with aspects of the embodiments. A tablet computer 101 can have a presentation device 102, a processor, memory, and input devices. An input device can be a pen input device, a track pad, a mouse interface, a touch sensitive screen, or other device. The presentation device 102 can be a flat panel display.

The presentation device 102 can present a graphical user interface (GUI) to a physician. The GUI can include a diagnoses field 105, an order field 108, a medication field 111, and an alert or alarm indicator 118. Here, the alarm indicator is a heavy frame around the other fields, perhaps colored red, which appears when the alarm module 114 has detected an alarm situation. Other possibilities for alarms are sounds or the highlighting of specific elements in the fields to indicate what is causing the alarm.

The diagnoses field 105 can include a number of suggested diagnoses 104. The order field can present a number of possible orders 106 and the medication field can present a number of possible medications. As illustrated, the physician has chosen one of the diagnoses as a selected diagnosis 103. The logic module 113 receives the selected diagnosis 103 and suggests two treatments as order suggestions 107 and one of the medications as a medication suggestion 109. The physician can clear a suggestion, select alternatives, or opt to do nothing in which case the suggestions automatically become the physician's selections.

The physician can authenticate the selections by signing on a signature pad 112. The physician's authentication transforms the selections into actual physician's orders for treatments to be performed and into ordered medications to be administered.

The reportable events module 116 detects events that must be reported to authorities. Gun shot wounds, certain infectious diseases, and child abuse are examples of reportable events. The reportable events module can alert the physician that an event must be reported. In some embodiments, the EPOS can directly and immediately report the event to the proper authorities.

The billing code module 115 can associate billing codes 117 with the possible orders 106, selected orders 107, possible medications 110, selected medications 109, physician's orders, and medication orders. Many medical treatment facilities currently employ people to attach billing codes to physician's orders and medication orders. The billing code module alleviates the need for such personnel.

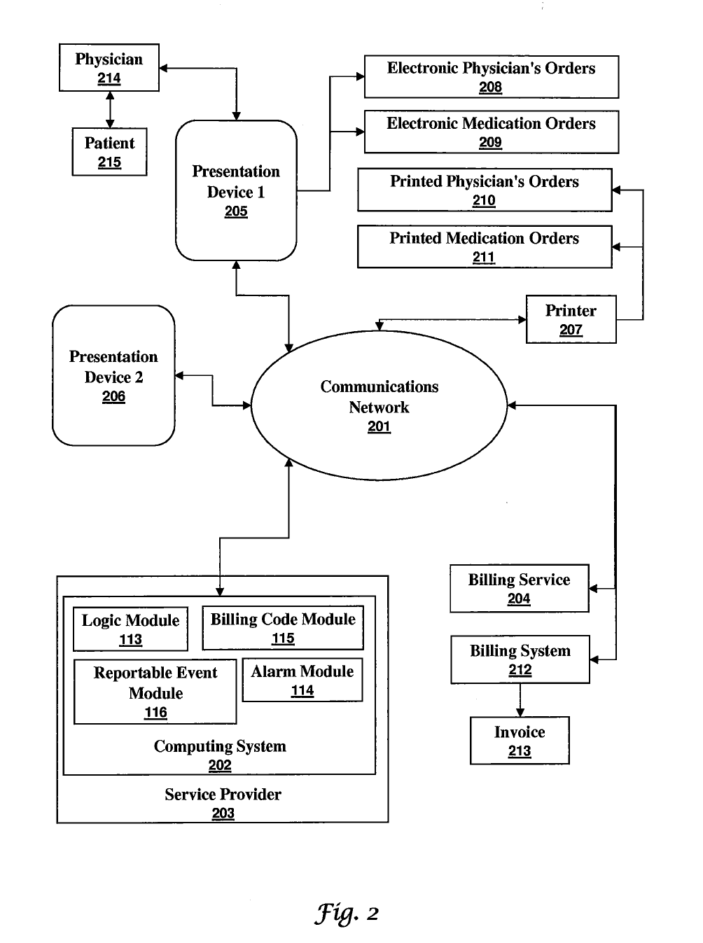

FIG. 2 illustrates a service provider 203 offering electronic physician's order sheets as a service in accordance with aspects of some embodiments. The service provider 203 provides and services a computing system 202 that is connected to a communications network 201 such as the internet, the phone network, a wireless network, or other communications fabric. The computing system 202 can include the logic module 113, the billing code module 115, the reportable events module 116, and the alarm module 114.

Other systems, services, and devices such as presentation device 1 205, presentation device 2 206, printer 207, billing service 204, and billing system 212 are connected to communications network and can use it to communicate with each other and with the computing system 202 of the service provider 203.

A physician 214 is shown using presentation device 1 205 to produce physician's orders and medication orders for the treatment of a patient 215. The orders issued from presentation device 1 205 are initially electronic physician's orders 208 and electronic medication orders 209. Electronic orders, when properly authenticated, can be obeyed in some health care facilities. The orders can be printed by a printer 207 to produce printed physician's orders 210 and printed medication orders 211. The physician 214 can physically sign the printed orders 210, 211 if needed.

The orders can also be transmitted to a billing service 204 and/or a billing system 212. A billing system 212 is typically a system that generates and tracks invoices 213 to ensure that a health care provider is compensated for providing care. A billing service 204 is generally a company under contract to a health care provider to generate invoices and, sometimes, to collect invoice payments.

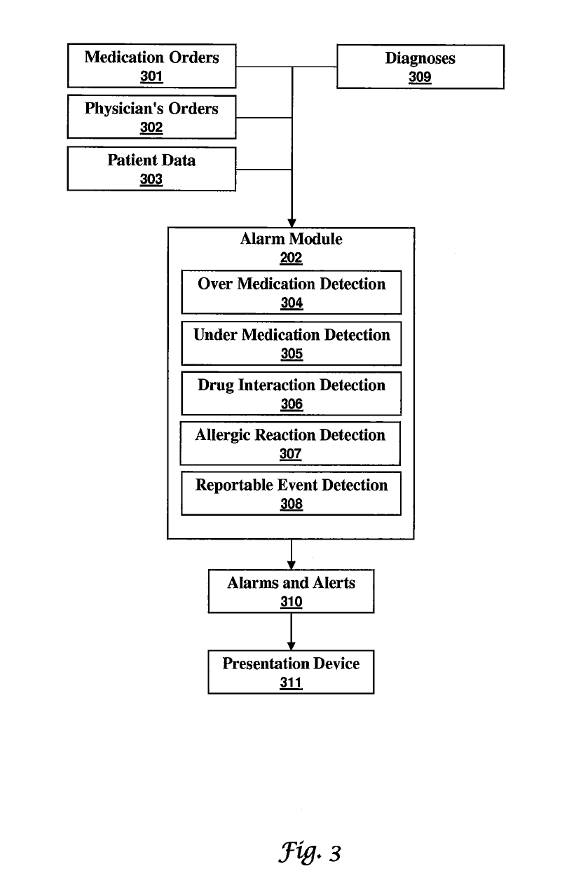

FIG. 3 illustrates an alarm module 202 that detects scenarios that can result in patient harm, in accordance with aspects of some embodiments. Medication orders 301, physician's orders 302, patient data 303, and diagnoses 309 can be input into the alarm module 202. The patient data 303 can be obtained during the patient intake process, during the course of treatment, or from previously obtained or produced medical records. The alarm module 202 can detect conditions or scenarios that can harm the patient such as over medication 304, under medication 305, drug interaction 306, and allergic reaction 307. The alarm module 202 can also function as a reportable event module by detecting reportable events 308. Upon detection, the alarm module 202 can produce alarms and/or alerts 310 and submit them to a presentation device 311. The presentation device 311 can be the very same device that a physician is using to submit diagnoses 309, can be a different device, or can be multiple devices.

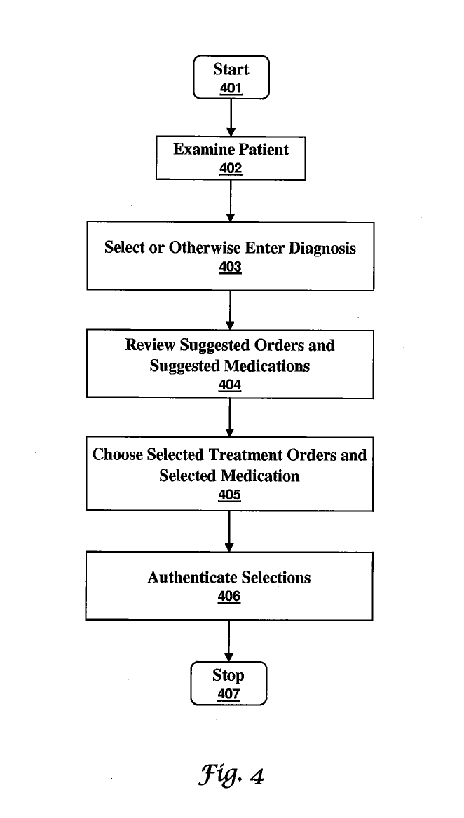

FIG. 4 illustrates a high level flow diagram of a physician using an electronic physicians order sheet in accordance with aspects of the embodiments. After the start 401 the physician examines a patient 402 and selects or otherwise enters diagnoses 403. The logic module then suggests treatment orders (aka order suggestions) and medication (medication orders) 404. The physician reviews the suggested orders and the suggested medications 404. If the suggestions are not what the physician wants, then other options can be selected (via checkbox, menu, etc.) or otherwise entered into the EPOS. In any case, the desired treatments and medications are selected 405. The physician then authenticates the selections 406 so that the appropriate orders are issued to caregivers, such as nurses, and to the pharmacy that provides the medications used to treat the patient. At this point, the process stops 407, at least until the physician again examines the patient 402.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system comprising:
a presentation device that presents a diagnosis field, a medication field, and an order field to a physician wherein the diagnosis field presents a plurality of suggested diagnoses to the physician and wherein the physician inputs a diagnosis by selecting at least one of the at least one suggested diagnoses;
a logic module that accepts the diagnosis and generates at least one order suggestion and at least one medication suggestion, wherein the at least one order suggestion is passed to the order field, wherein the at least one medication suggestion is passed to the medication field, and wherein the at least one order suggestion and the at least one medication suggestion are presented to the physician;
an order selection means wherein the physician approves or disapproves the at least one order suggestion to thereby generate at least one selected order;
a medication selection means wherein the physician approves or disapproves the at least one medication suggestion to thereby generate at least one selected medication; and
an authorization means whereby the physician authorizes the at least one selected order and the at least one selected medication such that the at least one selected order and the at least one selected medication become at least one physician's order and at least one medication order by which a patient receives treatment.

2. The system of claim 1 further comprising a billing code module that receives the at least one physicians order and the at least one medication order as input, wherein the billing code module supplements the at least one physicians order with a billing code, and wherein the billing code module supplements the at least one medication order with another billing code.

3. The system of claim 2 further comprising a billing system that automatically generates an invoice for delivery to a bill payer.

4. The system of claim 3 further comprising a communications network and a computer wherein the computer comprises the logic module and the billing code module, wherein the computer produces the suggested diagnoses, wherein the computer passes the suggested diagnoses through the communications network to the presentation device.

5. The system of claim 4 wherein a service provider maintains and operates the computer for a client base and wherein the client base comprises the physician.

6. The system of claim 5 further comprising an alarm module that produces an alert upon detecting a drug interaction wherein the alert is presented on the presentation device and to the physician.

7. The system of claim 6 further comprising a reportable event module that alerts the physician upon detection of a reportable event wherein a reportable event is an event that must be reported to an appropriate authority.

8. A system comprising:
a presentation device that presents a diagnosis field and an order field to a physician wherein the physician inputs a diagnosis into the diagnosis field;
a logic module that accepts the diagnosis and generates at least one order suggestion wherein the at least one order suggestion is then passed to the order field and presented to the physician;
an order selection means wherein the physician approves or disapproves the at least one order suggestion to thereby generate at least one selected order; and
an authorization means whereby the physician authorizes the at least one selected order such that the at least one selected order becomes at least one physicians order under which a patient receives treatment.

9. The system of claim 8 further comprising:
at least one suggested medication wherein the logic module generates the at least one suggested medication based on the diagnosis;
a medications field presented by the presentation device wherein the at least one suggested medication is passed to the medications field and presented to the physician;
a medication selection means wherein the physician approves or disapproves the at least one medication suggestion to thereby generate at least one selected medication that the physician then authorizes to thereby produce at least one medication order.

10. The system of claim 9 wherein the diagnosis field comprises a plurality of suggested diagnoses and wherein the physician inputs the diagnosis by selecting at least one of the at least one suggested diagnosis.

11. The system of claim 10 further comprising a printing device wherein the at least one selected order and the at least one medication order are printed by the printing device and thereafter signed by the physician.

12. The system of claim 10 wherein the physician electronically signs the at least one selected order and the at least one medication order.

13. The system of claim 9 further comprising a printing device wherein the at least one selected order and the at least one medication order are printed by the printing device and thereafter signed by the physician.

14. The system of claim 9 wherein the physician electronically signs the at least one selected order and the at least one medication order.

15. The system of claim 8 further comprising a printing device wherein the at least one selected order is printed by the printing device and thereafter signed by the physician.

16. The system of claim 8 wherein the physician electronically signs the at least one selected order.

17. A system comprising:
a presentation device that presents a diagnosis field, a medication field, and
an order field to a physician wherein the diagnosis field presents a plurality of suggested diagnoses to the physician and wherein the physician inputs a diagnosis by selecting at least one of the at least one suggested diagnoses;
a logic module that accepts the diagnosis and generates at least one order suggestion and at least one medication suggestion wherein the at least one order suggestion is then passed to the order field, wherein the at least one medication suggestion is then passed to the medication field, and wherein the at least one order suggestion and the at least one medication suggestion are presented to the physician;
an order selection means wherein the physician approves or disapproves the at least one order suggestion to thereby generate at least one selected order;
a medication selection means wherein the physician approves or disapproves the at least one medication suggestion to thereby generate at least one selected medication;
an alarm module that produces an alert upon detecting a drug interaction wherein the alert is presented on the presentation device and to the physician; and
an authorization means whereby the physician authorizes the at least one selected order and the at least one selected medication such that the at least one selected order and the at least one selected medication become at least one physicians order and the at least one medication order by which a patient receives treatment.

18. The system of claim 17 wherein the alarm module additionally detects a probable over medication and wherein the physician is alerted of the probable over medication.

19. The system of claim 17 wherein the alarm module additionally detects a probable under medication and wherein the physician is alerted of the probable under medication.

20. The system of claim 17 wherein the alarm module additionally detects a probable allergic reaction and wherein the physician is alerted of the probable allergic reaction.
